(19) United States
(12) Patent Application Publication
(10) Pub. No.: US 2005/0059749 A1
(43) Pub. Date: Mar. 17, 2005

(54) Catalysts useful in polyurethane foam

(75) Inventors: Pierre Chaffanjon, Douvaine (FR); Robert L. Zimmerman, Austin, TX (US)

Correspondence Address: Huntsman LLC;Legal Department, P.O. Box 15730, Austin, TX, 78761, US

(73) Assignee: Huntsman Petrochemical Corporation, Austin, TX (US)

(21) Appl. No.: 10/941,298

(22) Filed: Sep. 15, 2004

Related U.S. Application Data
(60) Provisional application No. 60/503,432, filed on Sep. 16, 2003.

(51) Int. Cl. C08J 9/00

(52) U.S. Cl. 521/99; 521/155

(57) ABSTRACT

The invention provides amine catalyst composition useful in producing a polyurethane foam, which catalyst comprises a material described by the general structure: 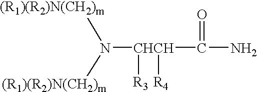
wherein R₁ and R₂ in each occurrence are independently selected from the group consisting of: methyl, ethyl, propyl, and butyl; m in each occurrence is any integer between 2 and about 10, including 2 and 10; and R₃ and R₄ are each independently selected from the group consisting of: hydrogen and C₁ to C₆ alkyl. flexible polyurethane foams produced using a catalyst according to the invention are low in odor, are not prone to discoloration, and have a low volatile organic chemical (VOC) content.

### CROSS-REFERENCES TO RELATED APPLICATIONS

This invention claims priority to U.S. Provisional Patent Application Ser. No. 60/503,432 which was filed Sep. 16, 2003 and which is currently still pending.

### TECHNICAL FIELD

This invention relates to catalyst systems useful in producing flexible polyurethane polyester foams. More particularly, it relates to catalysts for producing low-odor foams which are not prone to discoloration, and which have a low volatile organic chemical content.

### BACKGROUND INFORMATION

Many catalysts are known as being useful in producing various polyurethane-bearing foam products. Some of the known catalysts are described in the following US patents, the entire contents of each of which are fully incorporated herein by reference thereto: U.S. Pat. Nos. 6,232,356; 6,201,033; 6,114,403; 5,902,835; 5,859,079; 5,710,191; 5,633,293; 5,559,161; 5,539,007; 5,512,603; 5,508,314; 5,374,666; 5,356,942; 5,322,940; 5,308,882; 5,248,646; 5,238,894; 5,233,039; 5,229,430; 5,212,306; 5,194,609; 5,177,046; 5,168,009; 5,166,223; 5,162,379; 5,143,944; 5,130,403; 5,086,081; 5,057,480; 5,039,713; 4,789,689; 4,468,478; 4,465,791; 4,463,050; 4,426,320; 4,426,301; 4,404,121; 4,380,591; 4,379,757; 4,376,832; 4,353,995; 4,312,959; 4,297,443; 4,237,282; 4,228,248; 4,217,247; 4,194,069; 4,186,254; 4,184,023; and 4,122,038. In general, catalysts for polyurethane foams are classifiable as either blowing catalysts or gelling catalysts, depending on their relative catalytic activity respecting either generation of CO₂ via the water/isocyanate interaction or the gelling reaction via the OH/isocyanate interaction. Some have hypothesized that, generally, catalysts with a 3-atom spacing between active sites (viz. N, O) function predominantly as gelling catalysts, while catalysts with a 2-atom spacing between active sites (viz. N, O) function predominantly as blowing catalysts. Blowing catalysts and gelling catalysts are classified by those skilled in the art as either weak or strong, depending on the relative vigor with which they catalyze the blowing or gelling reaction.

Flexible polyurethane foams, including polyester-derived and polyether-derived foams, typically require specialized catalyst systems if stable, low-color foams are to be produced. Suitable catalysts are typically weak blowing catalysts such as N-ethyl morpholine and N-methyl morpholine. These weak blowing catalysts have very high vapor pressure, resulting in high amounts of odor in the foam and in the production area. Furthermore, these catalysts are relatively weak in activity, which means that relatively large amounts are required to produce stable foam at a reasonable production rate. The large amount of such catalyst that is required to be used further compounds the odor problems associated with the use of these catalysts. The use of strong gel catalysts such as 1,4-diazabicyclo[2,2,2]octane is not normally practiced since the amount required to give the proper initiation or cream time also results in tight foam that shrinks on storage. The above-mentioned morpholine-based catalysts produce white foams and color stable foams when employing certain reactant dyes.

Another weak blowing catalyst, methoxyethyl morpholine, may be used to produce ester foams, however the amount required is more twice that of N-ethyl morpholine. The foams produced are lower in odor due to the lower vapor pressure of methoxyethylmorpholine, but unfortunately the foams discolor or turn pink during curing. Combinations of gel catalysts such as N,N-dimethylpiperazine and weak blowing catalysts such as dimorpholinodiethylether have been practiced, but unfortunately these combinations produce foams that turn pink. Additionally, N,N-dimethylpiperazine has a high vapor pressure. While the use of N,N-dimethylpiperazine does produce lower odor foams than N-ethylmorpholine or N-methylmorpholine, this catalyst combination still produces a significant amount of VOC and odor in the foam production area.

Foams are also classified by those skilled in the art as being either “open” or “closed” foams. An open foam is one which the cell walls have ruptured, thus allowing the flow of air through the foam, while a closed foam is one which the cell walls are intact, and do not allow air to flow through the foam. In a flexible foam, a high content of closed cells causes the foam to shrink. Foams are also sometimes classified by those skilled in the art as being either “tight” or “open” foams. A tight foam is one which there is a significant amount of closed cells thus now allowing for free air flow, while a open foam is one which a significant percent of the cell walls have ruptured thus allowing excellent airflow through the foam. Foams may also be classified by those skilled in the art as being either “white” or “pink” foams. A white foam is one in which the foam has not discolored and appears white in color, while a pink foam is one that has a pink hue. This is observed most often in the center of the foam where the reaction temperature is higher due to the insulating properties of the foam. Additionally, foams may also be classified by those skilled in the art as being either “low-odor” or “high-odor” foams. A low-odor foam is one which has no apparent odor, while a high-odor foam is one which emits an odor which is noticeable. In those cases where amines are used as catalysts, the odor is often described as being “fish-like”.

### SUMMARY OF THE INVENTION

The present invention provides an amine catalyst composition useful in producing a polyurethane foam, which catalyst comprises a material described by the general structure: 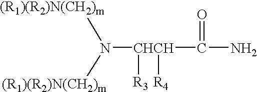
wherein R₁ and R₂ in each occurrence are independently selected from the group consisting of: methyl, ethyl, propyl, and butyl; m in each occurrence is any integer between 2 and about 10, including 2 and 10; and R₃ and R₄ are each independently selected from the group consisting of: hydrogen and C₁ to C₆ alkyl.

### BRIEF DESCRIPTION OF THE DRAWINGS

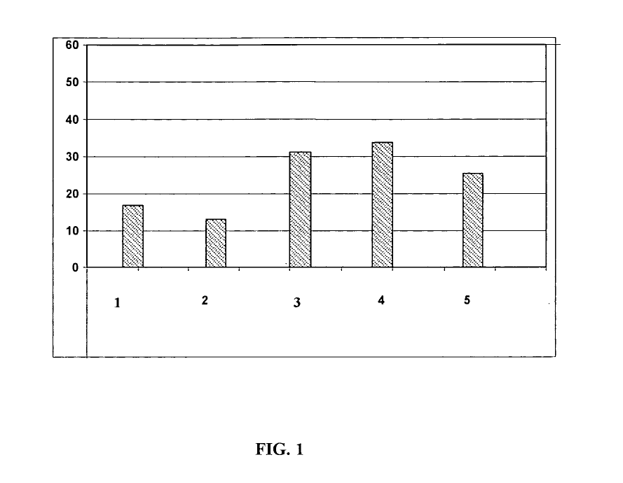

In the annexed drawing FIG. 1 shows Humid Aged Compression Set values for various foams produced during the course of experiments undertaken in connection with the present invention.

### DETAILED DESCRIPTION

The present invention is concerned with the use of amides according to the formula: 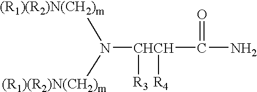
as either the sole catalyst, or as a component of a catalyst mixture, useful in the formation of a polyurethane elastomers or foam products from either a polyisocyanate and a polyester polyol, or a polyisocyanate and a polyether polyol. In the above structure, R₁ and R₂ in each occurrence may be independently selected from the group consisting of: methyl, ethyl, propyl, and butyl; m in each occurrence is any integer between 2 and about 10, including 2 and 10; and R₃ and R₄ are each independently selected from the group consisting of: hydrogen and C₁ to C₆ alkyl.

In one preferred embodiment, the invention is concerned with the use of 3-(bis-dimethylaminopropyl)amino)-propionamide as either the sole catalyst, or as a component of a catalyst mixture, useful in the formation of a polyurethane elastomer or foam product from either a polyisocyanate and a polyester polyol, or a polyisocyanate and a polyether polyol. The catalyst 3-(bis-dimethylaminopropyl)amino)-propionamide has the molecular structure: 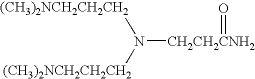
We refer to 3-(bis-(dimethylaminopropyl)amino)-propionamide as “DMAPAP”. This material may be synthesized as now provided, and its analogs may be synthesized using analogous starting materials as is readily recognized by those skilled in the art.

### Preparation of 3-(bis-(dimethylaminopropyl)amino)-propionamide

100 grams of N,N-bis(3-dimethylaminopropyl)amine is charged to a 500 ml three necked PYREX® glass flask equipped with magnetic stirrer, thermometer and reflux condenser, and heated under nitrogen to a temperature of 65° C. A solution made from combining and mixing 31.45 g of 97% acrylamide with 45 g ethanol is added dropwise over six hours, after which time the reaction mixture is kept at 65° C. for an additional 15 hours. Ethanol is removed by distillation, by heating at 100° C. in atmospheric conditions for 3 hours, and the product is then further dried under 4 mm Hg vacuum at 105-110° C. for 5 hours. 110 g. of product is obtained, light brown colored with no odor, confirmed by NMR as being 3-(bis-(dimethylaminopropyl)amino)-propionamide at a minimum purity level of 95 weight percent.

Other catalysts according to the invention are produced using similar raw materials. For example, when it is desired to alter the alkylene chain length defined by the variable m in the generic formula to a butylene group, an equivalent molar amount of the raw material N,N-bis(3-dimethylaminobutyl)amine is substituted in place of the N,N-bis(3-dimethylaminopropyl)amine in the example above. Similarly, the identities of R₁ and R₂ are controlled by the same raw material. For example to alter the R₁ and R₂ groups, one may begin utilize an equivalent molar amount of N,N-bis(3-diethylaminopropyl)amine in place of the N, N-bis(3-dimethylaminopropyl)amine in place of the N,N-bis(3-dimethylaminopropyl)amine in the example above in the example above to produce 3-(bis-(diethylaminopropyl)amino)-propionamide.

Catalyst compositions according to the present invention are of low relative volatility, and polyurethane products produced using the catalysts provided herein emit reduced amounts of gaseous residual catalyst materials when confined, as compared to polyurethane products produced using prior art catalysts. This is particularly true of 3-(bis-dimethylaminopropyl)amino)-propionamide. Thus a catalyst according to the present invention is especially useful in the manufacture of flexible polyurethane foam products, either polyether or polyester polyol based, for various end uses in the automotive, furniture, and bedding fields. The catalyst 3-(bis-(dimethylaminopropyl)amino)-propionamide contains hydrogen atoms which are reactive towards organic isocyanate groups, and this catalyst shows somewhat of a balanced catalytic behavior. However, it catalyzes the gelling reaction more than the blowing reaction, and is therefore probably best categorized as being a gelling catalyst on this basis.

The catalysts of the present invention perform well in higher density flexible material when a low emission characteristic is required, and especially when conditions of fabric staining, of PVC/polycarbonate discoloration or bad odor are to be avoided.

The catalysts of the invention are also useful in the manufacture of flexible foams which employ a water-blown formulation, particularly those commonly employed when producing foamed automotive or furniture seating components, which are based on an MDI isocyanate composition. The present catalysts are also well suited for use in systems which are free of blowing agents.

In addition, a catalyst according to the invention is useful in admixture with other catalysts of the prior art, including without limitation: JEFFCAT® ZF-10 catalyst, JEFFCAT® ZR-50 catalyst, dimethylaminopropyl-urea, bis(dimethylaminopropyl)urea, or any other catalyst compound or mixture of exhibiting a low emission performance compared to standard volatile non reactive catalysts such as JEFFCAT® TD-33A catalyst or JEFFCAT® ZF-22 catalyst in an emission test such as Volkswagen testing specification PV3341 or Daimler-Chrysler specification PB VWT 709.

Polyols useful in providing a polyurethane foam according to the present invention include polyester polyols having 2 or more reactive hydroxyl groups. Polyester polyols include those which are produced from a dibasic acid and a polyhydric alcohol such as, for example, polyethyleneadipate and polybutylene adipate. Any polyol may be used in accordance with the present invention, provided that it is based on a dibasic acid or anhydride and glycol (alcohol) with a functionality of 2.0 or more. Suitable dibasic acids include without limitation: adipic, succinic, glutaric, or mixtures of the foregoing. Suitable polyhydric alcohols include without limitation: ethylene glycol, propylene glycol, diethylene glycol, triethylene glycol, tetraethylene glycol, dipropylene glycol, tripropylene glycol and higher glycols of propylene, butylene glycol, dibutylene glycol, 1-6, hexanediol, 1,4-butanediol, 1,5 pentanediol, glycerol, trimethylolpropane, and methylglucosides.

Various surfactants, colors and dyes, other tertiary amines, metal catalysts, isocyanates, fire retardants, anti-static agents, coupling agents and other chemicals known by those skilled in the art as being useful in the production of urethane foams are suitable for inclusion when making a foam or other polyurethane product using a catalyst combination disclosed herein.

Three comparative catalysts blends have been employed herein to exemplify the benefits of the catalysts of the present invention. In each of these 3 combinations, the first catalyst is the “gel” component and the second is the “blow” component of the blend. The ratio and level of the two components in each blend has been adjusted to give similar foam processing in the selected formulation, meaning a similar reactivity and a similar molded foam quality. For the volatile blend, two ratios of JEFFCAT® TD-33A catalyst and JEFFCAT® ZF-22 catalyst have been used.

Comparative Catalyst system #1 contains JEFFCAT® TD-33A catalyst and JEFFCAT® ZF-22 catalyst. This blend is a traditional blend of catalysts regarded as typical of ‘fugitive’ or volatile catalysts, based on triethylene diamine (“TEDA”) and bis-dimethyl aminoethyl ether (“BDMAEE”) as catalyst structures. Two different formulations of this catalyst, with each component present in differing amounts, were employed in the comparative tests. This combination exemplifies what is generally regarded in the art as a volatile catalyst, and is represented by examples 1 and 2 in the tables below.

Comparative Catalyst system #2 contains JEFFCAT® ZR-50 catalyst and JEFFCAT® ZF-10 catalyst. This blend is a combination of low emission catalysts considered as typical of a best performance achievable with state-of-the-art available low emission grades. The catalysts structures are N,N-bis(3-dimethylaminopropyl)-N-isopropanolamine and N,N,N′-trimethyl-N′-hydroxyethyl-bisaminoethylether. This combination exemplifies what is generally regarded in the art as a low emission catalyst, and is represented by example 3 in the tables below.

Comparative Catalyst system #3 contains JEFFCAT® Z-130 catalyst and JEFFCAT® ZF-10 catalyst. This blend is a second combination of low emission catalysts also considered as typical of a best performance achievable with state-of-the-art available low emission grades. The catalysts structures are N,N-bis(3-dimethylaminopropyl)amine and N,N,N′-trimethyl-N′-hydroxyethyl-bisaminoethylether. This combination exemplifies what is generally regarded in the art as a low emission catalyst, and is represented by example 4 in the tables below.

In the comparative tests, foam reactivity was adjusted by the rise time in free rise mode, and was measured using the time required for a given formulation weight to fill the closed mold used, which is sometimes referred to as mold fill time by those skilled in the art. Tuning each system by varying the amounts of catalyst present in order to obtain similar mold fill times among the various samples ensures comparable processing when scaled-up on commercial processing equipment. A good molded foam quality is achieved when foams have enough open cells not to result in shrinkage after de-molding (being removed from the mold) and are stable enough not to present instability-related defects, such as corner voids. This has been achieved at a constant pour weight in the closed mold used for all the catalyst blend used.

3-(bis-(dimethylaminopropyl)amino)-propionamide (“DMAPAP”) has been compared to the above three combinations. It has been used by itself, its gel/blow selectivity did not require the use of a blow catalyst. Compared to the 3 catalyst blends mentioned above, the results obtained show that the catalyst of the invention has an improved performance balance of low emission combined with low compression sets. Compositions of the various catalysts employed are specified in Table I below.

| Formulation | 1 | 2 | 3 | 4 | 5 |
|---|---|---|---|---|---|
| Isocyanate | 60 | 60 | 60 | 60 | 60 |
| Pre-blend¹ | 106.5 | 106.5 | 106.5 | 106.5 | 106.5 |
| Crosslinker | — | 0.2 | 0.2 | — | 0.4 |
| Catalysts | | | | | |
| Gel | | | | | |
| JEFFCAT ® TD-33A catalyst | 0.55 | 0.40 | — | — | — |
| JEFFCAT ® ZR-50 catalyst | — | — | 0.70 | — | — |
| JEFFCAT ® Z-130 catalyst | — | — | — | 0.90 | — |
| DMAPAP | — | — | — | — | 0.80 |
| Blow | | | | | |
| JEFFCAT ® ZF-22 catalyst | 0.04 | 0.08 | — | — | — |
| JEFFCAT ® ZF-10 catalyst | | | 0.03 | 0.05 | — |
| Molding Results | | | | | |
| Reactivity - Mold fill time (sec.) | 78 | 75 | 66 | 73 | 55 |
| Overall Density (pcf) | 2.94 | 2.87 | 2.90 | 2.94 | 2.89 |

¹poly/water/surfactant/cell opener

All foams made during the testing were produced using the following formulation:

| Component | Parts by Weight |
|---|---|
| HR polyether triol, 6000 mol. W | 100 |
| Cell opener | 2 |
| Cell opener | varied |
| Surfactant | 0.5 |
| Water | 4 |
| Catalyst(s) | see table I |
| MDI based isocyanate | 60 |
| NCOᵥ = 32.6 | |

Foams were poured in a free rise bucket to optimize the catalyst levels in the formulations to a common reactivity level and similar foam stability. With the formulations at optimized levels, pours were made in a square metal closed mold pre-heated at 63° C. Internal mold dimensions are 10×40×40 cm. For both experiments, a pre-blend was prepared with all components except for the isocyanate and the catalysts. Both the pre-blended mixture and the isocyanate were conditioned by being kept at 25° C. for 20 minutes prior to use.

The mixing was done by first adding the catalyst to the pre-blended mixture and pre-mixing for 10 seconds under high shear. The isocyanate was then added to this blend and mixed for 8 seconds followed by immediate pour into the bucket or the closed mold. The same method was used for the FTIR experiments, 8 seconds mixing time ensures that well mixed material is poured on the IR sensor.

For the block moldings, the internal mold surface was sprayed with release agent. A constant mixing weight of 880 g total formulation was used, which corresponds to the minimum weight required to give a good quality molded foam block, free of defects using the control formulation. Foams were removed from the mold (“de-molded”) 5 minutes after mixing. During these molding experiments, the catalyst levels had to be fine-tuned to adjust processing for no foam shrinkage after cooling, as well as no block defect from foam instability. The blocks were cured under atmospheric conditions for at least 72 hours before physical properties were measured, in accordance with ASTM D3574 and ISO3386 standard methods.

Foams 1 and 2 from table I are the control foams and combined the two catalysts used the most in High Resilience (HR) MDI or TDI foam technologies: JEFFCAT® TD-33A catalyst and JEFFCAT® ZF-22 catalyst. The main difference between foams 1 and 2 is the ratio of the gel and blow catalysts. Decreasing the gel catalyst and increasing the blow catalyst (foam 2) also required addition of a crosslinker to ensure adequate foam stability.

Foams 3 and 4 contain a prior art catalyst combination in terms of low-emission catalysts. These formulations utilize JEFFCAT® ZR-50 catalyst or JEFFCAT® Z-130 catalyst as the gel catalyst and JEFFCAT® ZF-10 catalyst as the blow catalyst.

The catalysts utilized in foam 5 is produced using DMAPAP.

As targeted, all reactivity's are similar, with values for mold time-to-fill in the 60-80 second range, except for foam 5 which was somewhat faster at 55 second. The overall foam density for each example, as calculated from the block weight and mold volume, also falls within a narrow range, from 2.6 to 2.8 pounds per cubic foot or “pcf”.

The experimental catalyst levels used to achieve similar reactivity range from 0.8 to 2.0 parts for 100 parts polyol. These relatively low levels meet one of the objectives integrated into the design of the new catalysts, which is to minimize the amount of catalyst required in the formulation. A predominant mechanism for degradation after humid aging involves alkali-catalyzed hydrolysis of the chemical bonds in the polymer network, especially the urethane linkages. That being the case, minimizing the amount of catalyst should minimize property degradation after humid aging.

The crosslinker range used is also similar for the various foams, between 0.2 and 0.4 parts depending on the catalysts.

### Emission Testing

For the emission measurements, separate foams were produced with the same formulations as the moldings but in an open cardboard box, leading to a comparable foam volume. The foams were left uncut for curing at 25° C.+/3° in open atmosphere. After 24 hours, the blocks were cut and a sample of the core of the foam was taken for emission measurement. This ensured good control over cure time and avoids contamination from the release agent used for the closed mold pours. One gram of the foams to be tested for emissions was placed in a sealed vial that was heated to 120° C. for five hours. The heated headspace in the vial is injected into a gas chromatograph. A value relative to acetone is determined as micro grams of carbon per gram of sample (μgC/g). Two samples of each foam were analyzed and the results were averaged. This static headspace test was designed to be comparable to Volkswagen automotive emission test PV3341. Some result deviation may occur compared to this automotive test due to somewhat different GC experimental conditions. Regardless, the emission numbers generated provide a valuable comparative rating to assess the contribution of catalysts to foam emission.

### Foam Physical Properties

Table 2 summarizes the main physical properties measured on foams 1 to 5, done at an isocyanate ratio of 60 versus 100 parts of the main polyol. In terms of hardness and density, all foams can be regarded as comparable. The catalyst combinations tested gave foams in a relatively narrow 40% CLD hardness range, from 6 to 7 kPa.

TABLE 2
Main foam physical properties obtained from the molding experiments

| Formulation | 1 | 2 | 3 | 4 | 5 |
|---|---|---|---|---|---|
| Core Density (pcf) | 2.87 | 2.74 | 2.68 | 2.85 | 2.82 |
| Hardness, CLD 40%, | 6.90 | 6.13 | 7.00 | 6.90 | 6.40 |
| ISO3386 in kPa | | | | | |
| Hardness, CFD 50%, | 17.4 | 15.3 | 16.3 | 16.3 | 16.4 |
| ASTM D3574C, in kPa | | | | | |
| Dry Comp Set 75%, | 15.9 | 16.3 | 20.4 | 24.7 | 17.8 |
| ASTM D3574D, in % | | | | | |
| Humid Aged Comp. Set | 21.3 | 13.1 | 31.2 | 33.9 | 25.6 |
| 50% ASTM D3574J1 + D, | | | | | |
| in % | | | | | |
| Humid Aged Comp. Set | 26.9 | 23.6 | 51.5 | 56.9 | 36.7 |
| 75% ASTM D3574J1 + D, | | | | | |
| in % | | | | | |
| Tensile Strength, | 130 | 131 | 141 | 138 | 133 |
| ASTMD3574E, in kPa | | | | | |
| Elongation at break, | 185 | 177 | 188 | 187 | 177 |
| ASTMD3574E,in % | | | | | |
| Total Emissions | 20.5 | 21.3 | 7.6 | 6.1 | 11.6 |

The Humid Aged Compression Set (HACS) is a key property to monitor when low emission catalysts are used. The results show the trend that volatile catalysts contributing to emission (foams 1&2) give the best results, at respectively 17 and 13%. All other combinations show some degree of deterioration in the 22-35% range. These trends are visualized in FIG. 1, in which the numbers below the graphs correspond to the formulation number in tables 1 and 2. Of the low emission catalysts tested, DMAPAP gave the result of 25.6%. This represents an insignificant deterioration versus the JEFFCAT® TD33A catalyst/JEFFCAT® ZF-22 catalyst combination. Experimental catalyst 3 also gives a fair performance, though somewhat higher, at 27.2%.

The JEFFCAT® ZR-50 catalyst/JEFFCAT® ZF-10 catalyst and JEFFCAT® Z-130 catalyst/JEFFCAT® ZF-10 catalyst combinations of samples 3 and 4 give HACS values in the 30-35% range, which is clearly worse than the control foams. The ranking of the HACS results reflects fairly well the Dry Compression Set performance: foams 1 & 2 are the best, followed by foam 5. All the Dry Compression Set results are within a narrower range of 12 to 20%, as compared to the HACS results where variations between 13 and 34% are seen. This confirms that catalyst structural differences affect the static fatigue performance in a milder way in comparison to the property changes that follow humid aging, as quantified in this work by the HACS test. The mechanical strength of foams 3 to 5, as measured by tensile and elongation at break, are comparable to the control foams.

The two foams based on JEFFCAT® TD-33A catalyst and JEFFCAT® ZF-22 catalyst have the larger emission levels, both in the 20-25 μg.C/g range. For foams 1 and 2, the contribution of the two main catalyst molecules, triethylene diamine and bis-(2-dimethylamino ethyl)ether, represents 65 to 75% of the total foam emission.

With most of the low emission catalyst combinations, the foam emission level can be reduced by a factor of 3 to 4, the remaining part (about 5 μgC/g) being mainly the accumulation of small contributions of compounds not coming from the catalysts.

The performances of the JEFFCAT® ZR-50 catalyst/JEFFCAT® ZF-10 catalyst and JEFFCAT® Z-130/JEFFCAT® ZF-10 catalyst combination are amongst the best of the series. Experimental catalyst 2 has a somewhat larger emission contribution, reducing the total foam emission reduction only by half Compared to the control, this is still a substantial achievement.

One advantage of using DMAPAP catalyst by itself or in combination with another low emission catalyst (a “blowing catalyst”, according to one preferred form of the invention) is that, unlike gelling catalysts which are currently used to achieve low emission performance, DMAPAP also yields products having reduced levels of property degradation after aging in humid conditions.

Another advantage of the catalysts of the present invention is that DMAPAP can be used in flexible foam formulations free of blowing agent contributing to VOC and either by itself as catalyst or in combination with other low emission co-catalysts exclusively. Another advantage is that the catalyst of the present invention has low emission performance by both its low volatility as well as some reaction with the isocyanate groups during polyurethane formation. Another advantage of the present invention is that the emission contribution will be reduced compared to prior art catalysts such as 3-[3-(dimethylamino)propyl]-propionamide as described in EP 1 038 896 thanks to a higher molecular weight. Also, the use level is less than the amounts taught by the prior art. There are indications of this from EP 1 038 896 as example 3 shows that more than double the amount of JEFFCAT® TD-33A catalyst is needed for 3-[3-(dimethylamino)propyl]-propionamide.

Another advantage is that when using a catalyst according to the invention for preparing a polyurethane polyether or polyester foam is that the foams so formed are: 1) open celled; 2) low-odor; and 3) are low in VOC content.

Another advantage of the present invention is that a relatively low use level of DMAPAP is required to achieve a close foam reactivity, similar or lower to the level needed with other reactive low emission grades such as JEFFCAT® ZR-50 catalyst and JEFFCAT® Z-130 catalyst.

Another advantage of the present invention is that an improved foam emission level is attainable, as compared to the standard volatile catalyst blend JEFFCAT® TD33A catalyst/JEFFCAT® ZF-22 catalyst blend, as tested with a static headspace method based on the automotive Volkswagen PV3341 emission test principles. Though somewhat higher that the JEFFCAT® ZR-50 catalyst/JEFFCAT® ZF-10 catalyst and JEFFCAT® Z-130 catalyst/JEFFCAT® ZF-10 catalyst blends, the experimental catalyst is about half the level of emission compared to the JEFFCAT® TD-33A catalyst/JEFFCAT® ZF-22 catalyst based foam.

Another advantage of using a catalyst according to the invention is that improved compression set performance is observed compared to the JEFFCAT® ZR-50 catalyst/JEFFCAT® ZF-10 catalyst and JEFFCAT® Z-130 catalyst/JEFFCAT® ZF-10 catalyst blends, as measured with the dry Compression Set and Humid Aging Compression Set method ASTM 3574 Tests D and J1.

Overall, the experiments show that the DMAPAP catalyst performs similar to the other conventional volatile or non-volatile catalysts grades regarding foam expansion, foam density and foam cure. However, the emission characteristics are much better than a standard volatile catalyst blend such as JEFFCAT® TD-33A catalyst/JEFFCAT® ZF-22 catalyst and at the same time, the Compression Set results shows improved performance (lower remnant set) compared to both JEFFCAT® ZR-50 catalyst and JEFFCAT® Z-130 catalyst based blends.

One preferred temperature at which polyurethane foams may be produced in accordance with the invention is room temperature; however foams may be produced within the scope of the present invention at any temperature in the range from about 15° C. to about 50° C. The pressure range is preferably ambient, but any pressure in the range of from about 0.5 atmospheres to about 1.5 atmospheres is suitable for providing a polyurethane product using a catalyst combination disclosed herein.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims which follow.

1) An amine catalyst composition useful in producing a polyurethane foam, which catalyst comprises a material described by the general structure: 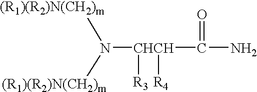
wherein R₁ and R₂ in each occurrence are independently selected from the group consisting of: methyl, ethyl, propyl, and butyl; m in each occurrence is any integer between 2 and about 10, including 2 and 10; and R₃ and R₄ are each independently selected from the group consisting of: hydrogen and C₁ to C₆ alkyl.

2) An amine catalyst according to claim 1 wherein R₁ and R₂ in each occurrence are methyl, wherein m in each occurrence equals 3, and wherein n equals 2.

3) An catalyst according to claim 1 wherein the vapor pressure of said composition is less than about 5 mm Hg @ 25° C.

4) An catalyst according to claim 1 wherein the vapor pressure of said composition is less than about 2 mm Hg @ 25° C.

5) A process for producing a polyurethane foam which comprises the steps of:
a) providing a diisocyanate;
b) providing a polyol; and
c) contacting said polyol with said diisocyanate in the presence of a catalyst mixture which comprises a material described by the general structure: 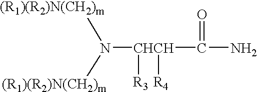
wherein R₁ and R₂ in each occurrence are independently selected from the group consisting of: methyl, ethyl, propyl, and butyl; m in each occurrence is any integer between 2 and about 10, including 2 and 10; and R₃ and R₄ are each independently selected from the group consisting of hydrogen and C₁ to C₆ alkyl.

6) A process according to claim 5 in which said catalyst comprises 3-(bis-(dimethylaminopropyl)amino)-propionamide.

7) A process according to claim 5 wherein said polyol is a polyester polyol.

8) A process according to claim 5 wherein said diisocyanate is a diisocyanate selected from the group consisting of 4,4′ diphenylmethane di-isocyanate and toluene diisocyanate.

9) A cured polyurethane foam which comprises residual amounts of a catalyst, said catalyst comprising a material described by the general structure: 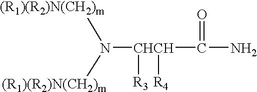
wherein R₁ and R₂ in each occurrence are independently selected from the group consisting of: methyl, ethyl, propyl, and butyl; m in each occurrence is any integer between 2 and about 10, including 2 and 10; and R₃ and R₄ are each independently selected from the group consisting of hydrogen and C₁ to C₆ alkyl, wherein the amount of residual catalyst present is any amount between 0.01 and 1.00% by weight based upon the total weight of said foam.

10) A foam according to claim 9 wherein said catalyst comprises 3-(bis-(dimethylaminopropyl)amino)-propionamide.

11) A composition from which a polyurethane polyester foam may be produced which comprises:
a) a polyol;
b) a catalyst that is described by the general structure: 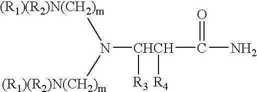
wherein R₁ and R₂ in each occurrence are independently selected from the group consisting of: methyl, ethyl, propyl, and butyl; m in each occurrence is any integer between 2 and about 10, including 2 and 10; and R₃ and R₄ are each independently selected from the group consisting of: hydrogen and C₁ to C₆ alkyl, wherein the amount of residual catalyst present is any amount between 0.01 and 1.00% by weight based upon the total weight of said foam.

12) A composition according to claim 11 wherein the vapor pressure of said composition is less than about 2 mm Hg @ 25° C.
